(19) United States
(12) Patent Application Publication
(10) Pub. No.: US 2023/0409411 A1
(43) Pub. Date: Dec. 21, 2023

(54) AUTOMATED PATTERN GENERATION FOR ELASTICITY IN CLOUD-BASED APPLICATIONS

(71) Applicant: SAP SE, Walldorf (DE)

(72) Inventors: Andreas Reischmann, Heidelberg (DE); Lena Rohde, St. Leon-Rot (DE); Felix Fischer, Leimen (DE); Maximilian Tomislav Stefanac, Heidelberg (DE); Waldemar Firus, Wiehl (DE); Rouven Krebs, Römerberg (DE)

(21) Appl. No.: 17/837,211

(22) Filed: Jun. 10, 2022

(51) Int. Cl. G06F 9/50; G06F 9/48

(52) U.S. Cl. CPC G06F 9/5083; G06F 9/505; G06F 9/4887

(57) ABSTRACT

Methods, systems, and computer-readable storage media for receiving a set of timeseries, each timeseries in the set of timeseries representing a parameter of execution of the system, resampling data of at least one timeseries to provide data of all timeseries in the set of timeseries in a consistent format, generating a pattern for each timeseries to provide a set of patterns based on data of the set of timeseries, combining patterns of the set of patterns to define a pattern, the pattern representing a schedule of instances over a period of time, and executing, by an instance manager, scaling of the system based on the pattern to selectively scale one or more of instances of the system and controllable resources based on scaling factors of the pattern.

### BACKGROUND

Enterprises can use enterprise applications to support and execute operations. Enterprise applications can be deployed in on-premise environments, which includes execution of the enterprise applications on enterprise-dedicated hardware, such as a server system within a data center of an enterprise. Enterprise applications are increasingly deployed in cloud-computing environments, which includes execution of the enterprise applications within a data center of a cloud-computing provider (e.g., as part of an infrastructure-as-a-service (IaaS) offering). In some instances, an enterprise may consider migrating an enterprise application deployed within an on-premise environment to a cloud-computing environment. In such a scenario, the enterprise application executing in the on-premise environment can be referred to as a legacy application.

However, applying the operation models from an on-premise deployment of a legacy application to a deployment within a cloud-computing environment can come with significantly increased costs. For example, an operation model can require that the enterprise application is to be available 24 hours per day, 7 days per week. In such an operation model, the operation costs can be significantly higher when deployed within a cloud-computing environment than if deployed on-premise. To leverage cost savings potential, cloud-computing systems continuously adapt their subscribed resources to workload-dependent resource requirements. This can be referred to as elasticity. For example, in timeframes where an enterprise application is rarely used, instances of the enterprise application can be shut down to reduce burden on technical resources and/or free technical resources for other uses.

### SUMMARY

Implementations of the present disclosure are directed to elasticity in cloud-computing environments. More particularly, implementations of the present disclosure are directed to automatic determination of patterns for elasticity in cloud-computing environments.

In some implementations, actions include receiving a set of timeseries, each timeseries in the set of timeseries representing a parameter of execution of the system, resampling data of at least one timeseries to provide data of all timeseries in the set of timeseries in a consistent format, generating a pattern for each timeseries to provide a set of patterns based on data of the set of timeseries, combining patterns of the set of patterns to define a pattern, the pattern representing a schedule of instances over a period of time, and executing, by an instance manager, scaling of the system based on the pattern to selectively scale one or more of instances of the system and controllable resources based on scaling factors of the pattern. Other implementations of this aspect include corresponding systems, apparatus, and computer programs, configured to perform the actions of the methods, encoded on computer storage devices.

These and other implementations can each optionally include one or more of the following features: actions further include extrapolating data of at least one timeseries to change a format of the at least one timeseries to the consistent format; parameters include one or more of load metrics, quality-oriented metrics, resource utilization metrics, configuration metrics, and application-specific metrics, application-specific metrics comprising one or more of request rate, number of users, response time, CPU utilization, and configuration of thread pool sizes; the pattern is provided as a weighted average of patterns in the set of patterns; actions further include aggregating data of timeseries from each of multiple periods in a timeframe of the timeseries to a period; resampling includes calculating a mean to data values for each sub-period of multiple sub-periods; and executing scaling includes one of starting and stopping execution of at least one instance to adjust a number of resources provisioned within at least one instance.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts an example conceptual architecture for use of logic scaling sets in accordance with implementations of the present disclosure.

FIG. 3 depicts example conceptual architecture for generating a pattern in accordance with implementations of the present disclosure.

FIG. 4 depicts an example process that can be executed in accordance with implementations of the present disclosure.

FIG. 5 is a schematic illustration of example computer systems that can be used to execute implementations of the present disclosure.

Like reference symbols in the various drawings indicate like elements.

### DESCRIPTION

Implementations of the present disclosure are directed to elasticity in cloud-computing environments. More particularly, implementations of the present disclosure are directed to automatic determination of patterns for elasticity in cloud-computing environments. Implementations can include actions of receiving a set of timeseries, each timeseries in the set of timeseries representing a parameter of execution of the system, resampling data of at least one timeseries to provide data of all timeseries in the set of timeseries in a consistent format, generating a pattern for each timeseries to provide a set of patterns based on data of the set of timeseries, combining patterns of the set of patterns to define a pattern, the pattern representing a schedule of instances over a period of time, and executing, by an instance manager, scaling of the system based on the pattern to selectively scale one or more of instances of the system and controllable resources based on scaling factors of the pattern.

Implementations of the present disclosure are described in further detail herein with reference to an example enterprise system provided as a landscape management system. An example landscape management system includes SAP Landscape Management (LaMa) and SAP Landscape Management Cloud (LaMa Cloud) provided by SAP SE of Walldorf, Germany. It is contemplated, however, that implementations of the present disclosure can be realized with any appropriate enterprise application.

To provide further context for implementations of the present disclosure, enterprises can use enterprise applications to support and execute operations. Enterprise applications can be deployed in on-premise environments, which includes execution of the enterprise applications on enterprise-dedicated hardware, such as a server system within a data center of an enterprise. More recently, enterprise applications are frequently deployed in cloud-computing environments, which includes execution of the enterprise applications within a data center of a cloud-computing provider (e.g., as part of an infrastructure-as-a-service (IaaS) offering). In some instances, an enterprise may consider migrating an enterprise application deployed within an on-premise environment to a cloud-computing environment. In such a scenario, the enterprise application executing in the on-premise environment can be referred to as a legacy application.

However, applying the operation models from an on-premise deployment to a deployment within a cloud-computing environment can come with significantly increased costs. For example, an operation model can require that an enterprise application is to be available 24 hours per day, 7 days per week. In such an operation model, the operation costs can be significantly higher when deployed within a cloud-computing environment than if deployed on-premise. To leverage cost savings potential, cloud-computing systems continuously adapt their subscribed resources to workload-dependent resource requirements. This can be referred to as elasticity. For example, in timeframes where an enterprise application is rarely used, instances of the enterprise application can be shut down to reduce burden on technical resources and/or free technical resources for other uses.

Scaling of systems is described in further detail in commonly U.S. application Ser. No. 16/912,870, filed on Jun. 26, 2020, and entitled Logic Scaling Sets for Cloud-like Elasticity of Legacy Enterprise Applications, the disclosure of which is expressly incorporated herein by reference for all purposes.

By way of non-limiting example, SAP LaMa, introduced above, supports enterprises in migrating on-premise deployments of enterprise applications to cloud-computing environments (e.g., IaaS offerings) in an effort to reduce resource consumption and associated costs borne by the enterprise. As part of this, services can be provided to scale instances of the enterprise application based on dynamic workloads. This scaling is typically achieved by starting instances (scale-out) and stopping instances (scale-in), such as application server instances. In a traditional approach, the enterprise can manually define patterns that scale an enterprise application based on a user-defined schedule. In general, a pattern can be described as a schedule of instances over a timeframe. For example, a user (e.g., an administrator employed by the enterprise) defines a certain scaling factor (e.g., percentage or number) of instances of the enterprise application for defined periods (e.g., hours) within a timeframe (e.g., day).

However, traditional approaches to defining patterns are manual, requiring user input, which includes several disadvantages. For example, the task of defining patterns requires knowledge of the dynamic resource demands of the system, knowledge of parameters that are relevant for a scaling decision and the degree to which individual parameters may be relevant, and knowledge on how to map individual resource demands to a respective number of needed instances/resources to meet the respective resource demand. Further, patterns must be designed to account for long-term capacity planning processes in information technology (IT) organizations. Manual patterns can be inefficient in terms of technical resources expended, if such a pattern were implemented. That is, for example, the pattern can scale-out instances, when such a scale-out is not actually required. On the other hand, manual patterns can scale-in instances, when such a scale-in results in insufficient resources, which can result in delays in processing requests.

In view of this, and as described in further detail herein, implementations of the present disclosure provide are directed to automatic determination of patterns for elasticity in cloud-computing environments. In some implementations, timeseries data representative of parameters of historical operation of a system are resampled and aggregated, and a set of patterns is provided. In some examples, each pattern is associated with a respective timeseries and indicates numbers of instances of a system that are to be provided over a timeframe (e.g., a period of time such as day, week, month). In some implementations, patterns in the set of patterns are combined to provide a combined pattern and the combined pattern is smoothed to provide a final pattern. The final pattern can be implemented for automatic scaling of the system based on the pattern.

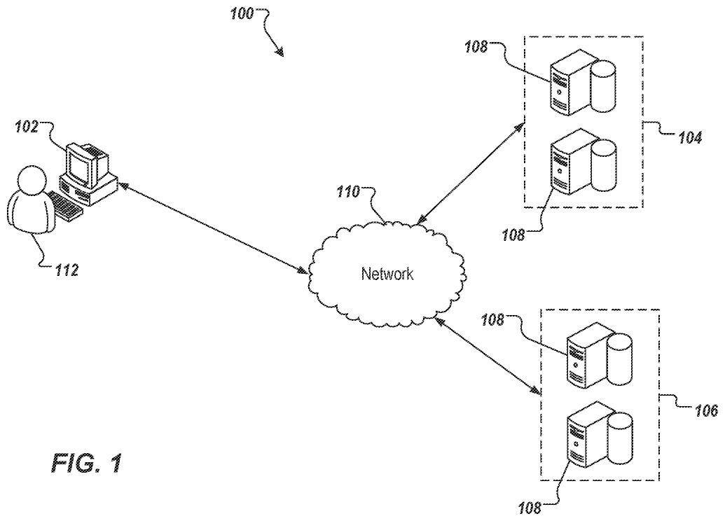

FIG. 1 depicts an example architecture 100 in accordance with implementations of the present disclosure. In the depicted example, the example architecture 100 includes a client device 102, a network 110, and server systems 104, 106. The server systems 104, 106 each include one or more server devices and databases 108 (e.g., processors, memory). In the depicted example, a user 112 interacts with the client device 102.

In some examples, the client device 102 can communicate with the server system 104 and/or the server system 106 over the network 110. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 110 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each of the server systems 104, 106 includes at least one server and at least one data store. In the example of FIG. 1, the server systems 104, 106 are intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host one or more managed systems (e.g., enterprise applications in a landscape) that support operations of one or more enterprises. Further, the server system 106 can host a landscape management system (e.g., SAP Landscape Management (LaMa) or SAP Landscape Management Cloud (LaMa Cloud)) that can be used to manage enterprise applications in a landscape. In some implementations, and as described in further detail herein, elasticity of instances of an enterprise application can be managed based on patterns, each pattern being a schedule of instances over a period (e.g., 1 week). For example, and as described in further detail herein, a pattern can define a number of instances of the application that are to be executed for each of multiple sub-periods (e.g., hours) over the period for a particular application. In some examples, each instance is executed by a respective server (e.g., application server). In this sense, each pattern can represent a schedule of servers over the period.

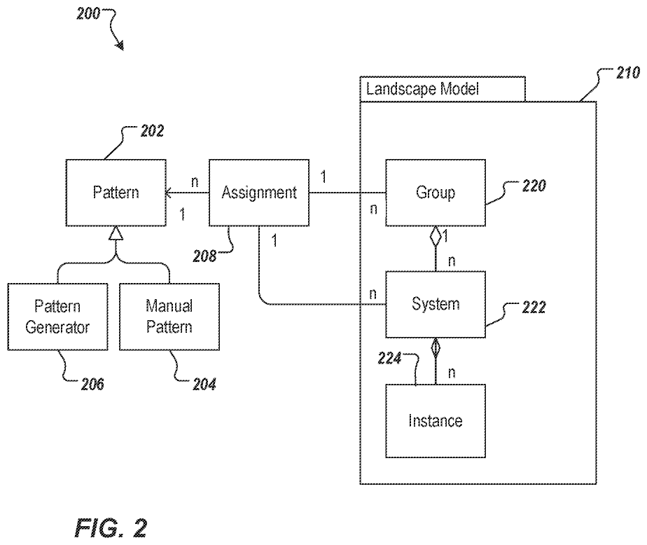

FIG. 2 depicts an example conceptual architecture 200 in accordance with implementations of the present disclosure. In the depicted example, the conceptual architecture 200 includes a pattern 202, a manual pattern 204, a pattern generator 206, an assignment 208, and a landscape model 210. The landscape model 210 includes a group 220, a system 222 (e.g., enterprise application executed within a landscape modeled by the landscape model 210), and an instance 224.

In some implementations, the assignment 208 associates the pattern 202 to either a group 220 or a system 222. For example, the assignment 208 can be provided as a data set that identifies a pattern 202 using a unique identifier that uniquely identifies the pattern 202 among a set of patterns, and that identifies one or more systems 222 and/or one or more groups 220 by respective unique identifiers that uniquely identify each system 222 or group 220.

Although a single group 220 is depicted in FIG. 2, one or more groups 220 can be defined within the landscape. Each group 220 is provided as computer-readable data that defines a set of systems (including one or more systems 222) that share some common properties (e.g., organization properties). For example, a group 222 can characterize workload behaviour that is the same for each system 222 in the set of systems. Accordingly, if the pattern 202 is associated with a group 220, the pattern 202 is applied to all of the systems 222 included in the group 220. Each group 220 can be of a different type of group. Example types of groups include, without limitation, a development group, a test group, a quality group, and a sandbox group. As noted above, each group 220 can include one or more systems 222.

Although a single system 222 is depicted in FIG. 2, one or more systems 222 can be executed within the landscape. In some examples, each system 222 provides one or more services to enterprises through execution of at least one enterprise application. Example services provided by a system can include, without limitation, enterprise resource planning (ERP) services, and customer relationship management (CRM) services. It is contemplated that implementations of the present disclosure can be realized with any appropriate enterprise application. As described herein, a system 222 can include one or more instances 224 of an enterprise application. More particularly, to be able to process potentially high workloads, a workload can be distributed across multiple instances 224.

In some implementations, the pattern 202 is provided as a computer-readable file that contains information on when a system (e.g., the system 222) or a group of systems (e.g., the group 220) is to be scaled within the landscape. The pattern 202 is provided as either the manual pattern 204 or an automatically generated pattern provided by the pattern generator 206. In some examples, the pattern 202 is provided as a computer-readable file that contains data defining a set of fixed periods within a timeframe and, for each period, an indication of a number of instances 224 of the system 222 that are to be running (e.g., scaled-out, scaled-in, stopped).

In accordance with implementations of the present disclosure, the pattern 202 is automatically generated by the pattern generator 206, which is provided as a computer-executable program.

In further detail, a set of timeseries that represents historical execution of workloads associated with an application is obtained. For example, an application can be executed by an enterprise for some timeframe (e.g., months, years). During that timeframe, data on parameters of the execution can be recorded. Example parameters can include, without limitation, a number of users (e.g., logged into the system), a utilization rate of central processing units (CPUs), request rate, and software wait times connection pooling). Although example parameters are discussed herein for purposes of illustration, it is contemplated that implementations of the present disclosure can be realized using any appropriate parameters.

In some examples, each timeseries represents a selected timeframe. An example timeframe can include a quarter within a year (e.g., approximately 13 weeks (91 days)). In some examples, timeseries data is provided in batches for a period of time within the timeframe. Consequently, the timeframe includes a latest period of time, if the latest period of time is complete (i.e., the batch of timeseries data for that period is available). By way of non-limiting example, the timeframe can include a quarter, which includes thirteen periods, each period being a week (i.e., a 13-week quarter). If the most-recent period is complete, data from the most-recent period is included in the timeseries. If the most-recent period is incomplete, data from the most-recent period is not included in the timeseries. In short, each timeseries accounts for the available batches of timeseries data extending backward in time for the timeframe.

In some examples, the set of timeseries includes a timeseries for each parameter in the set of parameters. In some examples, the set of timeseries is specific to a particular enterprise and/or system, for which patterns are to be generated. In some examples, each timeseries is provided as a list of timestamps and, for each timestamp, a parameter value. In some examples, a resolution of the timestamps can differ as between timeseries (e.g., depending on parameter). For example, and without limitation, the number of users can be provided at X minute intervals, while the request rate is provided at Y second intervals. In some examples, the timeseries may contain quality of service (QoS) related metrics (e.g., response times, throughput). Furthermore, configuration parameters (e.g., max work processes) or parameters providing insights into the actual application behaviour (e.g., number of executed batch processes) can be included.

In some examples, multiple timeseries are provided for a parameter in the set of parameters. For example, each timeseries can be associated with a parameter and an instance. If multiple instances have executed in the historical data, multiple timeseries are provided for the parameter, a timeseries for each instance. By way of non-limiting example, two instances can be executed within a period and a set of timeseries is provided for each instance. Each set of timeseries can include, for example, a first timeseries for a first parameter and a second timeseries for a second parameter.

In some implementations, data across one or more timeseries is resampled to bring all of the data into a consistent format (resolution). An example format can include, without limitation, one data point per hour. For example, an example timeseries (e.g., users, CPU load, active work processes, memory) can include one data point per minute. The following example table provides a non-limiting example for user timeseries data:

TABLE 1
Example User Timeseries Data
SYSID = 12345; SERVER = XYZ

| t_{m, 0} | t_{m, 1} | t_{m, 2} | t_{m, 3} | . . . | t_{m, n} |
|---|---|---|---|---|---|
| U₀ | U₁ | U₂ | U₃ | . . . | Uₙ |

In the example of Table 1, each timestamp (tₘ) represents a unique minute of n minutes (e.g., 131,040 minutes) in the timeframe (e.g., 13 weeks) and is associated with a respective user count (U). The example of Table 1 represents users for a particular instance (server). For example, and with reference to the above example, the example of Table 1 can represent users for the first instance. As discussed in further detail herein, multiple tables can be provided, one table for each instance that was active during the timeframe. For example, and with reference to the above example, another table can be provided to represent users for the second instance.

In some implementations, resampling of data of the example timeseries can include resampling to one data point per hour per instance (e.g., if there are multiple timeseries as a result of multiple instances). This can be achieved based on the following example pseudo-code:

Listing 1: Example Pseudo Code for Resampling

df_new =
df[columns].set_index(‘TIMESTAMP’).groupby( [‘SYSID’, ‘SERVER
’]) [metrics].resample(‘H’).mean( )
df_new = df_new.reset_index( )

In the example of Listing 1, a mean function is used for resampling. In some examples, depending on the parameters, the mean over a sub-period (e.g., an hour) is a representation that accurately reflects actual load in that sub-period. Referring to the example of Table 1, the following example table can be provided after resampling:

TABLE 2
Example Resampled User Timeseries Data
SYSID = 12345; SERVER = XYZ

| t_{h, 0} | t_{h, 1} | t_{h, 2} | t_{h, 3} | . . . | t_{h, p} |
|---|---|---|---|---|---|
| U_{mean, 0} | U_{mean, 1} | U_{mean, 2} | U_{mean, 3} | . . . | U_{mean, p} |

In the example of Table 2, each timestamp (tₕ) represents a unique hour of p hours (e.g., 2,184 hours) in the timeframe (e.g., 13 weeks) and is associated with a respective mean user count (Uₘₑₐₙ). Other functions (e.g., maximum, minimum, median) can be too sensitive to spikes (maximum) or ignore spikes altogether (minimum, median). If multiple timeseries are provided for the parameter (i.e., the historical data accounts for multiple instances), all observations are summed across the instances and a period (e.g., a week) is accounted for in a column (e.g., of a table that stores the timeseries data). This can be achieved based on the following example pseudo-code:

Listing 2: Example Pseudo-Code for Summing Timeseries Data

df_new = df_new[metrics +
[“TIMESTAMP”]].groupby(“TIMESTAMP”).sum( ).reset_index( )
df_new[“CALWEEK”] = d_new.TIMESTAMP.dt.year * 100 +
df_new.TIMESTAMP.dt.isocalendar( ).week

In some examples, sum is used to aggregate over instances for multiple reasons. For example, for the parameter of a number of users (USERS), each user is registered at one instance (server), and summing over instances provides the total number of users on the system. For example, and with reference to the above example, a number of users for each sub-period (e.g., hour) from the first timeseries is summed with a number of users for each sub-period (e.g., hour) from the second timeseries. As another example, for the parameter of active work processes (ACT_WPS), there can be active work processes on each instance, so summing over instances provides the total number of active work processes in the system. As another example, for the example parameter of CPU load (CPU_TOTAL), the CPU load is measured as a percent of the total available CPU capacity on an instance. Summing up CPU load across instances rests on the assumption that all instances have the same CPU capacity. In cases where the CPU capacity varies across instances, a different aggregation technique can be used. As still another example, for the parameter of memory used (EMALLOC), summing over instances provides the total memory consumed in the system.

In some implementations, data of a timeseries can be provided in blocks of time (e.g., blocks of hours). In view of this, data can be extrapolated to provide the data in the consistent format (e.g., one data point per hour). For example, for the parameter of request rate, the request rate can be provided in blocks of X hours (e.g., 4 hours). The following example table provides a non-limiting example for request rate:

TABLE 3
Example Request Timeseries Data
SYSID = 12345; SERVER = XYZ

| t_{b, 0} | t_{b, 1} | t_{b, 2} | t_{b, 3} | . . . | t_{b, q} |
|---|---|---|---|---|---|
| R_{1, 0} | R_{1, 1} | R_{1, 2} | R_{1, 3} | . . . | R_{1, q} |
| . . . | . . . | . . . | . . . | . . . | . . . |
| R_{j, 0} | R_{j, 1} | R_{j, 2} | R_{j, 3} | . . . | R_{j, q} |

In the example of Table 3, each timestamp (t_{b}) represents a unique block of q blocks in the timeframe (e.g., 13 weeks) and is associated with respective number of requests (R). In some examples, each block represents X hours. In the example of Table 3, different types of requests are accounted for in each block. For example, there can be j types of requests and a number of requests for each type of request is provided for each block.

To deduce values for each sub-period (e.g., housr), implementations of the present disclosure extrapolate the data of a block to sub-period values. In some examples, there is no way to infer which sub-period within a block of sub-periods contributed how much to the aggregate reported for the block. In view of this, implementations of the present disclosure divide the requests evenly across the block. For example, if Q requests are reported for a block of X hours (e.g., X≥2), a request rate of Q/X is provided for each hour in the block of hours.

It can occur, however, that the data should not be extrapolated across all sub-blocks (e.g., hours) in a block. For example, it can occur that the system was down (e.g., during updating of the system) for one or more sub-periods during the block of time. Consequently, data should not be extrapolated to the sub-period(s) of time, during which the system was down. To account for this, different approaches can be considered.

In a first example approach, metadata can be provided with the timeseries data, which indicates times, during which the system was down. For a block of time that the data is reported over, the data can be extrapolated only over those sub-periods (e.g., hours) that the system was not down. For example, if Q requests are reported for a block of X hours, and metadata indicates that the system was down for R hour(s) in the block of X hours, a request rate of Q/(X−R) is provided for the hours in the block of hours, during which the system was not down.

In a second example approach, timeseries of one or more other parameters can be analyzed to determine times, during which the system was down. For example, and without limitation, the timeseries for users can be analyzed to determine times, during which the system was down. In some examples, if a number of users is at or below a threshold number (e.g., zero users) for a sub-period of time, the system can be determined to be down for that sub-period of time. For a block of time that the data is reported over, the data can be extrapolated only over those sub-periods (e.g., hours) that the system was not down. For example, if Q requests are reported for a block of X hours, and the timeseries of another parameter indicates that the system was down for R hour(s) in the block of X hours, a request rate of Q/(X−R) is provided for the hours in the block of hours, during which the system was not down.

Referring to the example of Table 3, the following example table can be provided after resampling:

TABLE 4
Example Extrapolated Request Timeseries Data
SYSID = 12345; SERVER = XYZ

| t_{h, 0} | t_{h, 1} | t_{h, 2} | t_{h, 3} | . . . | t_{h, p} |
|---|---|---|---|---|---|
| R′_{1, 0} | R′_{1, 1} | R′_{1, 2} | R′_{1, 3} | . . . | R′_{1, p} |
| . . . | . . . | . . . | . . . | . . . | . . . |
| R′_{j, 0} | R′_{j, 0} | R′_{1, 2} | R′_{j, 3} | . . . | R_{j, p} |

In the example of Table 4, each timestamp (tₕ) represents a unique hour of p hours in the timeframe (e.g., 13 weeks) and is associated with respective extrapolated number of requests (R′). By way of non-limiting example, t_{b,1} of Table 3 can represent a block of 4 hours, where each of t_{h,1}, t_{h,2}, t_{h,3}, and t_{h,4} is a sub-period (hour) within t_{b,1}. Continuing with this example, and assuming that the system was not down during t_{b,1}, R′_{1,1}, R′_{1,2}, R′_{1,3}, and R′_{1,4} are each equal to R_{1,1} divided by 4. Continuing with this example, and assuming that the system was down during t_{h,2} of t_{b,1}, R′_{1,1}, R′_{1,3}, and R′_{1,4} are each equal to R_{1,1} divided by 3, and R′_{1,2} is equal to 0.

In some examples, an example timeseries (e.g., request rate) includes one data point per hour, but includes multiple entries for each hour, each entry corresponding to a respective type. This is depicted in the example of Table 4, in which, multiple request rates are for each sub-period (e.g., a request rate for each type of request). In this case, the data are aggregated within the sub-period to provide a single data point per sub-period. This can be achieved based on the following example pseudo-code:

Listing 3: Example Pseudo-Code to Sum over Entries

df_new = df[ [‘STEPS’,
‘TIMESTAMP’] ].set_index(‘TIMESTAMP’).resample(‘H’).sum( )
df_new = df_new.reset_index( )

Referring to the example of Table 4, the following example table can be provided after resampling:

TABLE 5
Example Aggregated Extrapolated Request Timeseries Data
SYSID = 12345; SERVER = XYZ

| t_{h, 0} | t_{h, 1} | t_{h, 2} | t_{h, 3} | . . . | t_{h, p} |
|---|---|---|---|---|---|
| R′_{total, 0} | R′_{total, 1} | R′_{total, 2} | R′_{total, 3} | . . . | R′_{total, p} |

In the example of Table 5, each timestamp (tₕ) represents a unique hour of p hours in the timeframe (e.g., 13 weeks) and is associated with respective aggregate number of requests (R′ₜₒₜₐₗ).

As described above, data of timeseries is resampled to bring all of data into a consistent format (resolution). Using the non-limiting example of one data point per hour, the following example table can be provided as output from resampling:

TABLE 6
Example Timeseries Data

| t_{h, 0} | t_{h, 1} | t_{h, 2} | t_{h, 3} | . . . | t_{h, p} |
|---|---|---|---|---|---|
| U_{mean, 0} | U_{mean, 1} | U_{mean, 2} | U_{mean, 3} | . . . | U_{mean, p} |
| R′_{total, 0} | R′_{total, 1} | R′_{total, 2} | R′_{total, 3} | . . . | R′_{total, p} |
| . . . | . . . | . . . | . . . | . . . | . . . |

In the example of Table 6, the data values can account for aggregate data values across all instances represented in the historical data.

In some implementations, the timeseries data is aggregated over a period of time. For example, if the timeframe is provided in weeks (e.g., 13 weeks), the time series data is aggregated over each week (e.g., the period is provided as a week). In some examples, for aggregation over a week, an artificial time column (TIMEPOINT) is created that references an hour (sub-period) in the week, in which a respective timestamp is located. In some examples, the first hour Monday morning is referenced by a first value (e.g., 0) and the last hour on Sunday evening is referenced by a second value (e.g., 167). In some examples, the mean is determined over all timepoints. This can be achieved based on the following example pseudo-code:

Listing 4: Example Pseudo-Code to Aggregate Over Weeks

df_new[“TIMEPOINT”] = 24 * df_new.TIMESTAMP.dt.weekday +
df_new.TIMESTAMP.dt.hour
df_new = df_new[columns].groupby(“TIMEPOINT”).mean( )

Accordingly, each of the data values of the respective timeseries are aggregated per hour over all weeks in the timeframe. Continuing with the non-limiting examples above, the following example table can be provided:

TABLE 7
Example Aggregated Timeseries Data per Week

| Monday | | | Tuesday | | | . . . | Sunday | |
|---|---|---|---|---|---|---|---|---|
| t₀ | t₁ | . . . | t₂₄ | t₂₅ | . . . | . . . | t₁₆₆ | t₁₆₇ |
| U_{agg, 0} | U_{agg, 1} | . . . | U_{agg, 24} | U_{agg, 25} | . . . | . . . | U_{agg, 166} | U_{agg, 167} |
| R′_{agg, 0} | R′_{agg, 1} | . . . | R′_{agg, 24} | R′_{agg, 25} | . . . | . . . | R′_{agg, 166} | R′_{agg, 167} |
| . . . | . . . | . . . | . . . | . . . | . . . | . . . | . . . | . . . |

Accordingly, Table 7 represents an aggregation of timeseries data values for each hour of one week. For example, timestamp t₀ is a first hour of the week, U_{agg,0} is an aggregate number of users across all instances for timestamps t_{h,0}, t_{h,168}, t_{h,336}, . . . , t_{h,2016}, and R′_{agg,0} is an aggregate of the aggregated extrapolated requests across all instances for timestamps t_{h,0}, t_{h,168}, t_{h,336}, . . . , t_{h,2016}. As another example, timestamp t₁₆₇ is a last hour of the week, U_{agg,167} is an aggregate number of users across all instances for timestamps t_{h,167}, t_{h,335}, t_{h,503}, . . . , t_{h,2183}, and R′_{agg,167} is an aggregate of the aggregated extrapolated requests across all instances for timestamps t_{h,167}, t_{h,335}, t_{h,503}, . . . , t_{h,2183}.

In accordance with implementations of the present disclosure, a set of patterns is generated, each pattern corresponding to a respective parameter. As described in further detail herein, a pattern is generated based on the aggregated timeseries data for the parameter for period. For example, and with reference to the non-limiting example of Table 7, a first pattern is generated for users based on the values U_{agg,0}, . . . , U_{agg,167}, and a second pattern is generated for requests based on the values R′_{agg,0}, . . . , R′_{agg,167}. As described herein, each pattern indicates a number of instances (servers) that are to be provided for each sub-period within the period. For example, a pattern indicates a number of instances (servers) for each hour within a week.

In some implementations, for each parameter, a maximum value is determined for the period (e.g., week) and is used as a reference point. For example:

reference_point=sorted(list(df[metric]))[−1] Listing 5: Example Reference Point Determination

In the example of Listing 5, the parameter is indicated as metric. In some implementations, a factor is determined that can be used to adjust the pattern based on a selected aggressiveness. For example:

factor=(100+aggressiveness)/140 Listing 6: Example Factor Calculation

In some examples, aggressiveness is selected in a range from 0 to 100, where 0 is maximally conservative and 100 is maximally aggressive. In some examples, a value of 0 results in a factor of 1/1.4 which is approximately 1/sqrt(2), and a value of 100 will result in a factor of 2/1.4 which is approximately sqrt(2).

In some examples, different calculations are used to generate patterns for different parameters (metrics). In general, however, for each sub-period (e.g., hour) the value of the parameter is multiplied by a maximum number of instances (servers) that can be made available and this is divided by the reference point. For example:

$${I}_{rec , i} = \frac{{v}_{i} \times {I}_{max}}{ref}$$

where I_{rec,i} is a number of recommended instances (servers) for the i^{th} sub-period, vᵢ is the value (i.e., the aggregated timeseries data value) of the parameter for the i^{th} sub-period, Iₘₐₓ is maximum number of instances (servers) that can be made available, and ref is the reference point (reference_point). Accordingly, I_{rec,i} can be described as a recommendation of the maximal number of instances for the maximum observed values and a linear reduction based on the parameter values.

In some implementations, this calculation is complemented with adjustments. In a first example adjustment, 1 is added to I_{rec,i}. In this manner, the minimum number of recommended instances is at least 1. In a second example adjustment, the result is converted to an integer, by rounding I_{rec,i}+1 up to the next integer (e.g., 2.35 is rounded up to 3). In a third example adjustment, it is determined whether the integer result is in a predefined range of [1, 2, . . . , Iₘₐₓ] by applying a maximum and a minimum. In this manner, a final recommended number of instances for the sub-period (I_{REC,i}) is determined.

With particular reference to the parameter of extended memory (EMALLOC), the parameter value for any given period will be relatively high. For example, instead of being in a range of [0, 1], values for extended memory will likely be in a range of [0.8*reference_point, reference_point]. Consequently, the process for determining I_{REC,i} will almost always recommend that all available instances be run (i.e., I_{REC,i}=Iₘₐₓ). In view of this, for the parameter of extended memory, implementations of the present disclosure scale from the reference point to the minimum value in the period. For example:

Listing 7: Example Scaling

lambda x: max(1, min(num_app_servers,
int(num_app_servers *
(x-minimum) / (reference_point-minimum) )+1) ) )

In some implementations, the factor can be applied. For example:

Listing 8: Example Scaling with Factor

lambda x: max(1, min(num_app_servers,
int(num_app_servers * (x-minimum) / (reference point-
minimum) *factor)+1) ) )

In the examples of Listings 7 and 8, num_app_servers is the final recommended number of instances (I_{REC,i}) determined for the i^{th} sub-period using the general approach described above. In the above calculations, a linear scaling of the number of servers is performed. Further, the result of linear scaling is transformed to an integer value to ensure that a whole number of application servers is recommended. Also, the number is shifted slightly upwards to ensure that situations can occur, in which all available application servers are recommended. Finally, the minimum and maximum statements ensure that at least one application server is recommended and ensure that not more than the maximally available application servers are recommended.

With particular reference to the parameter of total CPUs used (CPU_TOTAL), this presents a special case, because the absolute value of CPU_TOTAL, can directly be interpreted. In some examples, a mean CPU load (e.g., 60%) is set as a threshold CPU load, at or above which, a next instance (server) is to be added. Accordingly, below the mean CPU load, one instance is provided, between the mean CPU load and twice the mean CPU load (e.g., 60% and 120%), two instances are provided, and so on. In some examples, a different version of aggressiveness is used by ranging a threshold value (cpu_per_appserver) in a range (e.g., [50, 70]). For example:

Listing 9: Example Ranging

cpu_per_appserver = 50 + int(aggressiveness / 5)
lambda x: max(1, min(num_app_servers, 1 + (x / /
cpu_per_appserver) ) )

In some implementations, for all other parameters (e.g., parameters other than memory, CPU), the general approach described above is used and the reference point is multiplied by the aggressiveness factor. For example:

Listing 10: Application of Factor

lambda x: max (1, min(num_app_servers,
int(num_app_servers * x / (reference_point * factor) )
+ 1) )

As described herein, implementations of the present disclosure provide a set of patterns is generated, each pattern corresponding to a respective parameter. In accordance with implementations of the present disclosure, patterns in the set of patterns are combined to provide a single pattern for the period (e.g., week). In some implementations, patterns are combined using a weighted average. For example, for a first parameter (parameter a) a first weight (wₐ) is provided and, for a second parameter (parameter b) a second weight (w_{b}) is provided. The patterns of the first parameter and the second parameter can be combined using the following example relationship:

$${I}_{com , i} = \frac{( {w}_{a} {I}_{a , i} + {w}_{b} {I}_{b , i} )}{{w}_{a} + {w}_{b}}$$

where I_{com,i} is the number of instances for the i^{th} sub-period, I_{a,i} is the number of instances for the i^{th} sub-period from the pattern determined for the first parameter, and I_{b,i} is the number of instances for the i^{th} sub-period from the pattern determined for the second parameter. Although the above discussion addresses combining two patterns, it is appreciated that implementations of the present disclosure can be extended to address combining any appropriate number of patterns. For example, for three patterns, the following example relationship can be provided:

$${I}_{com , i} = \frac{( {w}_{a} {I}_{a , i} + {w}_{b} {I}_{b , i} + {w}_{c} {I}_{c , i} )}{{w}_{a} + {w}_{b} + {w}_{c}}$$

In some implementations, the combined pattern is smoothed to remove any spikes either up or down. In this manner, relatively rapid starting/stopping of instances can be avoided. In some examples, smoothing is achieved by identifying any cases in which a pattern either goes down in one sub-period and up again in a next sub-period or vice-versa. In some examples, if such a spike is identified, the number of instances is adjusted to replicate from the beginning of a multi-sub-period (e.g., multi-hour) window to the middle. For example:

Listing 11: Example Pseudo-Code for Smoothing

if (new_series[i] = new_series[ (i−1)%168] ) *
(new_series[i] − new_series[ (1+1)%168] ) > 0:
new_series[i] = new_series[ (i−1)%168]

For purposes of illustration, non-limiting examples can be considered. In one example, the combined pattern provides that, for Monday morning 6-8 AM, there are 2 instances at 6 AM, 3 instances at 7 AM, and 2 instances at 8 AM. In view of this, smoothing is applied as described herein to smooth the combined pattern to a pattern of 2 instances at 6 AM, 2 instances at 7 AM, and 2 instances at 8 AM. As another example, the combined pattern provides that, for Monday morning 6-8 AM, there are 2 instances at 6 AM, 1 instance at 7 AM, and 2 instances at 8 AM. In view of this, smoothing is applied as described herein to smooth the combined pattern to a pattern of 2 instances at 6 AM, 2 instances at 7 AM, and 2 instances at 8 AM. The rationale for this adjustment is multi-fold. For example, pattern recommendations with spikes up/down are erratic, which negatively impacts trust in the pattern. As another example, because starting and stopping instances is not instantaneous, starting/stopping an instance for just one sub-period is not a resource-efficient strategy.

In accordance with implementations of the present disclosure, the (smoothed) combined pattern is used to selectively scale instances of a system within a cloud computing environment. For example, an instance manager can selectively scale the system based on the combined pattern to selectively scale one or more of instances of the system and controllable resources based on scaling factors of the combined pattern.

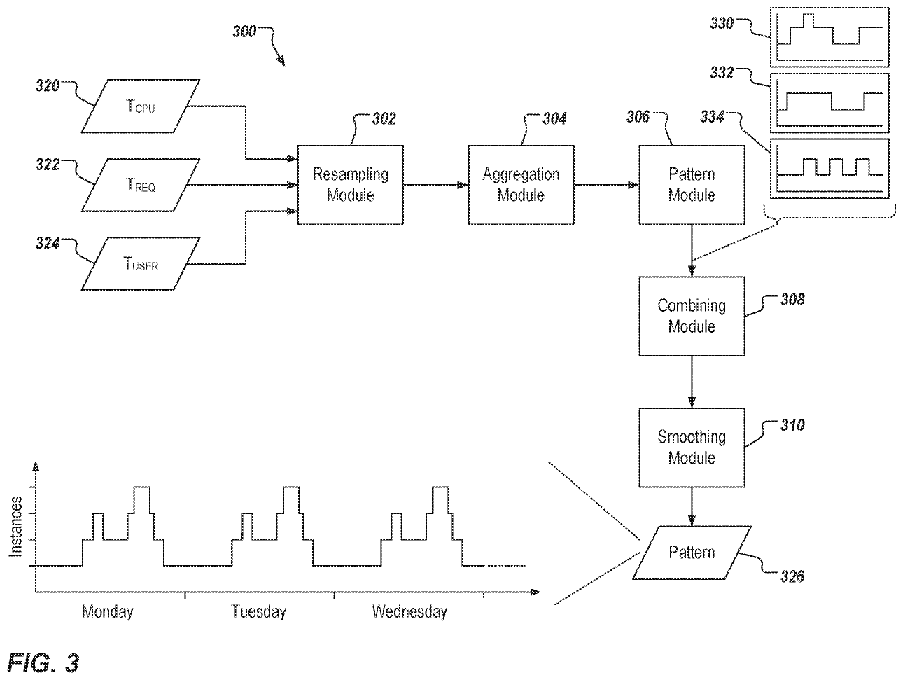

FIG. 3 depicts example conceptual architecture 300 for automatically generating a combined pattern in accordance with implementations of the present disclosure. In the example of FIG. 3, the conceptual architecture 300 includes a resampling module 302, an aggregation module 304, a pattern module 306, a combining module 308, and a smoothing module 310. As described in further detail herein, timeseries 320, 322, 324 are processed to provide a pattern 326.

In further detail, the resampling module 302 resamples data values in respective timeseries 320, 322, 324, as needed, to provide data values in a consistent format (resolution). An example format can include, without limitation, one data point per hour. For example, each timeseries 320, 322, 324 represents a respective parameter in a set of parameters and is recorded over a timeframe (e.g., 13 weeks). The timeseries 320, 322, 324 can have different resolutions (e.g., data per second, data per minute, data over a block of time). The resampling module 302 resamples data values in respective timeseries 320, 322, 324, as needed, to provide data values in a consistent format (resolution), as described herein.

In some examples, the (resampled) timeseries are each provided to the aggregation module 304, which aggregates data values to each sub-period within a period. By way of non-limiting example, and as discussed above, a timeframe can include 13 weeks, and a period can be provided as a week. For a unique hour (sub-period) of a week (e.g., timestamps t_{h,0}, t_{h,168}, t_{h,336}, . . . , t_{h,2016} representing the first hour of each Monday across all 13 weeks), the data values for each instance of that unique hour are aggregated. In this manner, for each timeseries, an aggregate timeseries is provided that represents a single period (e.g., 1 week aggregated from data values of a 13-week timeframe).

In some examples, the (aggregate) time series are each provided to the pattern module 306, which processes the respective timeseries to provide a respective pattern, as described herein. For example, a pattern 330 is provided, which corresponds to the timeseries 320, a pattern 332 is provided, which corresponds to the timeseries 322, and a pattern 334 is provided, which corresponds to the timeseries 324. The patterns 330, 332, 334 are provided to a combining module 308, which combines the patterns 330, 332, 334 to provide a combined pattern, as described herein. The combined pattern is provided to a smoothing module 310, which smooths the combined pattern, as needed and as described herein, to provide the pattern 326. In the example of FIG. 3, the pattern 326 provides a schedule of a number of instances per sub-period (hour) per period (week).

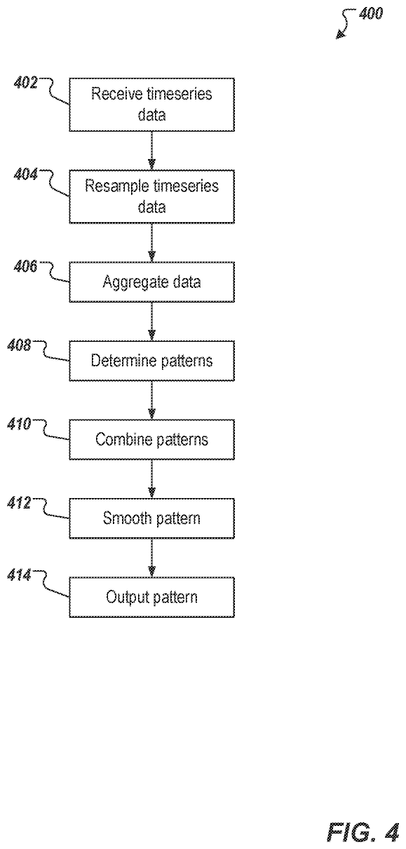

FIG. 4 depicts an example process 400 that can be executed in accordance with implementations of the present disclosure. In some examples, the example process 400 is provided using one or more computer-executable programs executed by one or more computing devices.

Timeseries data is received (402). For example, and as described herein, a set of timeseries that represents historical (actual) execution of workloads associated with an application is obtained. For example, an application can be executed by an enterprise for some timeframe (e.g., months, years). During that timeframe, data on parameters of the execution can be recorded. Example parameters can include, without limitation, a number of users (e.g., logged into the system), a utilization of central processing units (CPUs), request rate, and software wait times (e.g., connection pooling). In some examples, a set of timeseries can represent synthetic execution of workloads associated with an application. That is, timeseries in the set of timeseries is artificially generated.

Timeseries data is resampled (404). For example, and as described herein, data across one or more timeseries is resampled to bring all of the data into a consistent format (resolution). An example format can include, without limitation, one data point per hour. Consequently, and by way of non-limiting example, data provided per minute can be aggregated over each hour (e.g., mean over an hour) to provide a single data value for the respective hour. In some examples, data values are extrapolated, such as for data provided in batches representing multiple sub-periods. For example, and as described herein, data of one or more timeseries can be provided in blocks of time (e.g., blocks of hours). In view of this, data can be extrapolated to provide the data in the consistent format (e.g., one data point per hour).

Timeseries data is aggregated (406). For example, and as described herein, data values are aggregated to each sub-period within a period. By way of non-limiting example, and as discussed above, a timeframe can include 13 weeks, and a period can be provided as a week. For a unique hour (sub-period) of a week (e.g., timestamps t_{h,0} t_{h,168}, t_{h,336}, . . . , t_{h,2016} representing the first hour of each Monday across all 13 weeks), the data values for each instance of that unique hour are aggregated. In this manner, for each timeseries, an aggregate timeseries is provided that represents a single period (e.g., 1 week aggregated from data values of a 13-week timeframe).

A set of patterns is determined (408). For example, and as described herein, a pattern is generated for each timeseries in the set of timeseries. In some examples, for each sub-period (e.g., hour) the value of a respective parameter is multiplied by a maximum number of instances (servers) that can be made available and this is divided by a reference point, the reference point being a maximum value of the parameter. The patterns are combined (410). For example, and as described herein, patterns are combined to provide a single pattern as a weighted average. The pattern is smoothed (412). For example, and as described herein, the pattern is smoothed to remove up/down spikes, if any. The pattern is output (414). For example, and as described herein, patterns can be displayed to a user. In some examples, a pattern is selected for used in the landscape. For example, a user can select the pattern and can assign the pattern to a system. In some examples, instances of the system are automatically scaled in/out based on the pattern. In some examples, a pattern that is automatically generated can be manually adjusted. For example, the user can adjust the pattern before deploying the pattern for use in the landscape.

Implementations of the present disclosure provide the following example advantages. Implementations of the present disclosure provide for automated generation of patterns that, although abstractly, accurately represent a dynamic behavior of systems. In this manner, patterns enable resource efficiencies to be obtained through accurately provisioning instances and avoiding resource-wasteful execution of instances when not needed. Further, the patterns of the present disclosure mitigate risk of unexpected or non-deterministic system scaling to provide predictive system behavior. This enables activities, such as compliance, scheduling maintenance windows, and alerting. Also, the patterns of the present disclosure eliminate traditional problems such as oscillation, overcompensation, slow convergence, and delayed reaction (e.g., scaling up too late).

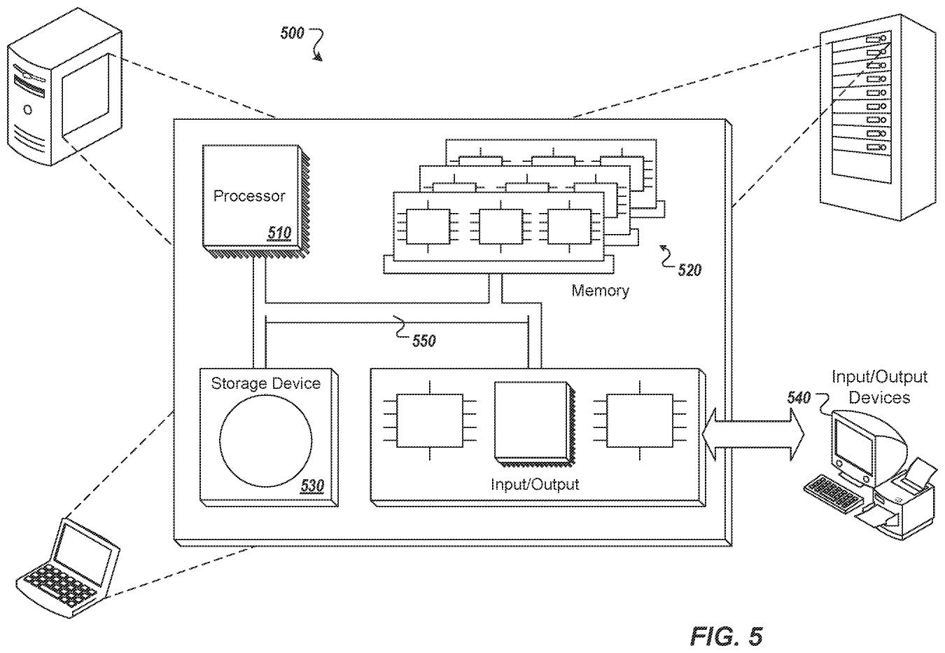

Referring now to FIG. 5, a schematic diagram of an example computing system 500 is provided. The system 500 can be used for the operations described in association with the implementations described herein. For example, the system 500 may be included in any or all of the server components discussed herein. The system 500 includes a processor 510, a memory 520, a storage device 530, and an input/output device 540. The components 510, 520, 530, 540 are interconnected using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530 to display graphical information for a user interface on the input/output device 540.

The memory 520 stores information within the system 500. In some implementations, the memory 520 is a computer-readable medium. In some implementations, the memory 520 is a volatile memory unit. In some implementations, the memory 520 is a non-volatile memory unit. The storage device 530 is capable of providing mass storage for the system 500. In some implementations, the storage device 530 is a computer-readable medium. In some implementations, the storage device 530 may be a floppy disk device, a hard disk device, an optical disk device, or a tape device. The input/output device 540 provides input/output operations for the system 500. In some implementations, the input/output device 540 includes a keyboard and/or pointing device. In some implementations, the input/output device 540 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for selective scaling of a system based on scaling one or more of instances executed within a landscape and controllable resources used for execution within the landscape, the method being executed by one or more processors and comprising:
receiving a set of timeseries, each timeseries in the set of timeseries representing a parameter of execution of the system;
resampling data of at least one timeseries to provide data of all timeseries in the set of timeseries in a consistent format;
generating a pattern for each timeseries to provide a set of patterns based on data of the set of timeseries;
combining patterns of the set of patterns to define a pattern, the pattern representing a schedule of instances over a period of time; and
executing, by an instance manager, scaling of the system based on the pattern to selectively scale one or more of instances of the system and controllable resources based on scaling factors of the pattern.

2. The method of claim 1, further comprising extrapolating data of at least one timeseries to change a format of the at least one timeseries to the consistent format.

3. The method of claim 1, wherein parameters comprise one or more of load metrics, quality-oriented metrics, resource utilization metrics, configuration metrics, and application-specific metrics, application-specific metrics comprising one or more of request rate, number of users, response time, CPU utilization, and configuration of thread pool sizes.

4. The method of claim 1, wherein the pattern is provided as a weighted average of patterns in the set of patterns.

5. The method of claim 1, further comprising aggregating data of timeseries from each of multiple periods in a timeframe of the timeseries to a period.

6. The method of claim 1, wherein resampling comprises calculating a mean to data values for each sub-period of multiple sub-periods.

7. The method of claim 1, wherein executing scaling comprises one of starting and stopping execution of at least one instance to adjust a number of resources provisioned within at least one instance.

8. A non-transitory computer-readable storage medium coupled to one or more processors and having instructions stored thereon which, when executed by the one or more processors, cause the one or more processors to perform operations for selective scaling of instances of a system executed within a landscape, the operations comprising:
receiving a set of timeseries, each timeseries in the set of timeseries representing a parameter of execution of the system;
resampling data of at least one timeseries to provide data of all timeseries in the set of timeseries in a consistent format;
generating a pattern for each timeseries to provide a set of patterns based on data of the set of timeseries;
combining patterns of the set of patterns to define a pattern, the pattern representing a schedule of instances over a period of time; and
executing, by an instance manager, scaling of the system based on the pattern to selectively scale one or more of instances of the system and controllable resources based on scaling factors of the pattern.

9. The non-transitory computer-readable storage medium of claim 8, wherein operations further comprise extrapolating data of at least one timeseries to change a format of the at least one timeseries to the consistent format.

10. The non-transitory computer-readable storage medium of claim 8, wherein parameters comprise one or more of load metrics, quality-oriented metrics, resource utilization metrics, configuration metrics, and application-specific metrics, application-specific metrics comprising one or more of request rate, number of users, response time, CPU utilization, and configuration of thread pool sizes.

11. The non-transitory computer-readable storage medium of claim 8, wherein the pattern is provided as a weighted average of patterns in the set of patterns.

12. The non-transitory computer-readable storage medium of claim 8, wherein operations further comprise aggregating data of timeseries from each of multiple periods in a timeframe of the timeseries to a period.

13. The non-transitory computer-readable storage medium of claim 8, wherein resampling comprises calculating a mean to data values for each sub-period of multiple sub-periods.

14. The non-transitory computer-readable storage medium of claim 8, wherein executing scaling comprises one of starting and stopping execution of at least one instance to adjust a number of resources provisioned within at least one instance.

15. A system, comprising:
a computing device; and
a computer-readable storage device coupled to the computing device and having instructions stored thereon which, when executed by the computing device, cause the computing device to perform operations for selective scaling of instances of a system executed within a landscape, the operations comprising:
receiving a set of timeseries, each timeseries in the set of timeseries representing a parameter of execution of the system;
resampling data of at least one timeseries to provide data of all timeseries in the set of timeseries in a consistent format;
generating a pattern for each timeseries to provide a set of patterns based on data of the set of timeseries;
combining patterns of the set of patterns to define a pattern, the pattern representing a schedule of instances over a period of time; and
executing, by an instance manager, scaling of the system based on the pattern to selectively scale one or more of instances of the system and controllable resources based on scaling factors of the pattern.

16. The system of claim 15, wherein operations further comprise extrapolating data of at least one timeseries to change a format of the at least one timeseries to the consistent format.

17. The system of claim 15, wherein parameters comprise one or more of load metrics, quality-oriented metrics, resource utilization metrics, configuration metrics, and application-specific metrics, application-specific metrics comprising one or more of request rate, number of users, response time, CPU utilization, and configuration of thread pool sizes.

18. The system of claim 15, wherein the pattern is provided as a weighted average of patterns in the set of patterns.

19. The system of claim 15, wherein operations further comprise aggregating data of timeseries from each of multiple periods in a timeframe of the timeseries to a period.

20. The system of claim 15, wherein resampling comprises calculating a mean to data values for each sub-period of multiple sub-periods.
